(19) United States
(12) Patent Application Publication
(10) Pub. No.: US 2014/0249928 A1
(43) Pub. Date: Sep. 4, 2014

(54) SHELF TO CONSUMER PLATFORM

(71) Applicant: SHELFBUCKS, Austin, TX (US)

(72) Inventors: Erik Andrew McMillan, Austin, TX (US); Michael Scheschuk, Austin, TX (US); Kevin Stambaugh, Austin, TX (US)

(21) Appl. No.: 14/183,116

(22) Filed: Feb. 18, 2014

Related U.S. Application Data
(63) Continuation-in-part of application No. 14/171,544, filed on Feb. 3, 2014.
(60) Provisional application No. 61/760,018, filed on Feb. 1, 2013.

(51) Int. Cl. G06Q 30/02

(52) U.S. Cl. CPC G06Q 30/0267
USPC 705/14.64

(57) ABSTRACT

The present disclosure provides a system, apparatus and means for addressing the limitations of existing technology and practices with respect to in-store advertising. The present disclosure enables marketers to direct commercial messages to consumers whilst enabling consumers to control or influence if and when messages are received, as well as the content of the messages. The disclosure can provide this functionality is through the use of broadcast beacons and demand beacons. The disclosure also provides a means for interacting with applications located on PEDs, including from a sleeping or non-active state and ensuring that the messages transmitted are secure. The disclosure also provides a means for marketers to design, track and alter in real-time a marketing strategy, including on a store-by-store basis.

### CROSS-REFERENCE TO RELATED APPLICATIONS

This applications claims priority to U.S. Non-Provisional patent application Ser. No. 14/171,544, filed Feb. 3, 2014, which is hereby incorporated by reference in its entirety.

This applications also claims priority to U.S. Provisional Patent Application Ser. No. 61/760,018]], filed Feb. 2, 2013, which is hereby incorporated by reference in its entirety.

### BACKGROUND OF THE INVENTION

It is without argument that traditional printed media has undergone a decline in readership and circulation as evidenced by the closure of many reputable newspaper companies and the continued movement towards an Internet-based medium.

Linked to this continuing decline in circulation of printed mediums, including, but not limited to, pamphlets, coupons, and printed specials, is advertisers' effectiveness in reaching and influencing consumers.

Marketers are therefore recognizing the need to move away from the use of traditional printed mediums to more modern Internet or electronic based solutions. This has resulted in an increase of digital advertisements, which has spurred a technological spike in presenting, tracking and analyzing the effectiveness of those advertisements. However, this spike in electronic advertisement has resulted in an oversaturation of this medium, resulting in return-on-ad-spend stagnation for some advertisers.

The declining readership and circulation of printed material and the difficulty of being noticed in a saturated Internet-based medium, limits a company's capacity to influence the consumer shopping behavior, especially in a real time or in-store environment.

Stores have responded by developing individualized smartphone applications for the purpose of influencing consumer behavior. However, the proliferation of these applications has delivered additional challenges to consumers, whereby multiple applications repeatedly send push message advertisements to consumers, and consumers increasingly ignore them, thereby limiting the consolidated effectiveness of these applications.

Furthermore, in-store advertisement platforms have traditionally lacked the ability to be customized to address an individual consumer's purchase intent or specific request for offer and information engagement, or on the basis of brand driven actions, or on the basis of consumer shopping trends.

Traditional marketing methods typically place product prices, discounts, and paper coupons on or around an item in order to capture the attention of consumers. This results in a visually polluted environment, which is expensive and time consuming to maintain, and can distract consumers from purchasing.

Accordingly, there is a need for technological advancements in the industry in order to overcome these existing limitations, including enabling brands and retailers to influence consumer behavior in real-time, while maintaining consumers' ability to manage the content and flow of information they receive.

### BRIEF SUMMARY OF THE INVENTION

The present disclosure provides a means to address the limitations that exist in the present technology.

The present disclosure provides a means for consumers to manage the amount and the content of commercial messages, including advertisements, received on their PEDs.

The present disclosure provides a system for broadcasting in-store commercial messages to consumers' personal electronic devices.

One embodiment of the system provides commercial messages to consumers that are customizable by marketers based on a variety of parameters. Such parameters can include, but are not limited to, a consumer's past shopping history, loyalty to a particular product or store, or various other means.

A further embodiment provides for commercial messages that are customizable by consumers. This enables consumers to choose when and where they receive advertisements, and the type/product to which the advertisement relate.

A further embodiment includes a demand beacon that requires a consumer to place a personal electronic device in proximity before commercial messages are broadcast.

A further embodiment includes a broadcast beacon where commercial messages are broadcast to all connected PEDs.

One embodiment of the beacon transmits a first transmission for activating a specific application and establishing a secure link to the beacon. Upon establishing a secure link between the beacon and a device, the beacon broadcasts a second transmission, in the same or a differing protocol, which includes the commercial messages.

One embodiment of the present disclosure includes an offer platform that provides a means for marketers to design and implement potential marketing programs.

One embodiment of the present disclosure includes an analytics platform that provides a means for marketers to track and analyze the success of a marketing program.

One embodiment of the present disclosure includes a computational program that enables control over the positioning of commercial messages presented to consumers, as well as the likelihood of their presentation.

One embodiment of the present disclosure is capable of interacting with retailers existing legacy marketing programs, and adapting the output for incorporation and presentation to consumers.

A further embodiment of the present disclosure can prevent the bombardment of consumers with advertisements by enabling a consumer to make an active decision before obtaining more information about a product. Consumer interaction with a beacon enables the presentation (via an application) of the currently available coupons (or specials) for the product in question. In an embodiment, the coupons presented could additionally include related products, products of a similar brand, or products located in the vicinity of the product queried.

### BRIEF DESCRIPTION OF THE DRAWINGS

The novel features believed characteristic of the disclosed subject matter will be set forth in the subsequent claims. The disclosed subject matter itself, however, as well as a preferred mode of use, further objectives, and advantages thereof, will best be understood by reference to the following detailed description of an illustrative embodiment when read in conjunction with the accompanying drawings, wherein:

FIG. 1 illustrates an exemplary computer system of the present disclosure.

FIG. 2A AND FIG. 2B illustrate exemplary personal electronic devices of the present disclosure.

FIG. 3 illustrates exemplary componentry of a personal electronic device of the present disclosure.

FIG. 4 illustrates an exemplary schematic representation of a system of the present disclosure.

FIG. 5 illustrates a flow chart diagram for the use of an exemplary system.

FIG. 6 illustrates an exemplary broadcast beacon interacting with an associated “store” application.

FIG. 7 illustrates an exemplary analytics platform of the present disclosure.

FIG. 8 illustrates a further embodiment of an analytics platform of the present disclosure pertaining to existing offers.

FIG. 9 illustrates an exemplary demand beacon position on a shelf that is displaying products.

FIG. 10 illustrates a consumer interacting with an exemplary demand beacon.

FIG. 11A, 11B, 11C, 11D, and 11E illustrate screenshots outputs from an exemplary application as viewed by a consumer.

FIG. 12 illustrates a screenshot of an exemplary application as viewed by a consumer upon completion of the shopping experience.

FIG. 13 illustrates an exemplary screenshot output of the present disclosure.

FIG. 14 illustrates an exemplary screenshot of an input interface for interaction by a marketer.

FIG. 15 illustrates an exemplary screenshot output of the present disclosure.

FIG. 16 illustrates a screenshot of an exemplary user input screen for managing commercial messages

FIG. 17 illustrates interaction of the exemplary aspects of the present disclosure.

### DETAILED DESCRIPTION OF ILLUSTRATIVE EMBODIMENTS

In the drawings reference numbers are used throughout the different figures to designate the same components.

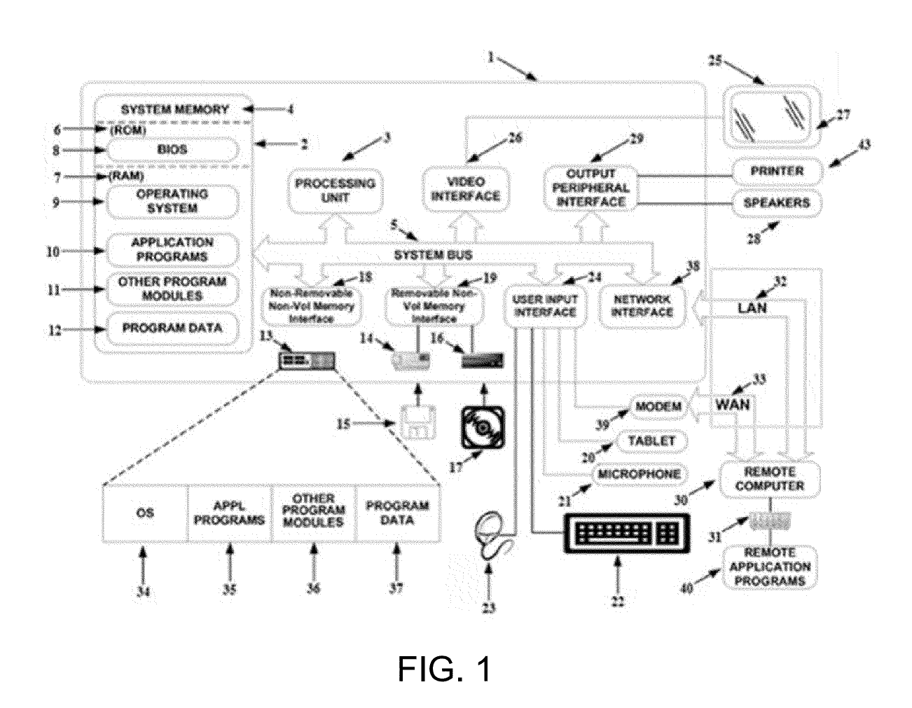

With reference to FIG. 1, an exemplary system within a computing environment for implementing the disclosure includes a general purpose computing device in the form of a computing system 1, such as, but not limited to, those commercially available from Intel, IBM, AMD, Motorola, Cyrix, etc. Components of the computing system 2 may include, but are not limited to, a processing unit 3, a system memory 4, and a system bus 5 that couples various system components including the system memory 4 to the processing unit 3. The system bus 5 may be any of several types of bus structures including a memory bus or memory controller, a peripheral bus, or a local bus using any of a variety of bus architectures.

Computing system 1 may include a variety of computer readable media. Computer readable media can be any available media that can be accessed by the computing system 1 and include volatile, nonvolatile, removable, and non-removable media. By way of example, computer readable media may comprise computer storage media and communication media. Computer storage media includes volatile and nonvolatile, removable, and non-removable media implemented in any method or technology for storage of information such as computer readable instructions, data structures, program modules, or other data.

Computer memory may include, but is not limited to, RAM 7, ROM 6, EEPROM, flash memory or other memory technology, CD-ROMs, digital versatile disks (DVD) or other optical disk storage, magnetic cassettes, magnetic tape, magnetic disk storage or other magnetic storage devices, or any other medium which can be used to store the desired information and which can be accessed by computing system 1.

System memory 4 may include computer storage media in the form of volatile and/or nonvolatile memory such as ROM 6 and RAM 7. A basic input/output system 8 (BIOS), containing the basic routines that help to transfer information between elements within computing system 1 (such as during start-up) is typically stored in ROM 6. RAM 7 typically contains data and/or program modules that are immediately accessible to and/or presently being operated on by processing unit 3. By way of example, and not limitation, an operating system 9, application programs 10, other program modules 11 and program data 12 are shown.

Computing system 1 may also include other removable, non-removable, volatile, and nonvolatile computer storage media, or a combination thereof. By way of example, a hard disk drive that reads from or writes to non-removable, nonvolatile magnetic media, a magnetic disk drive 14 that reads from or writes to a removable, nonvolatile magnetic disk 15, and an optical disk drive 16 that reads from or writes to a removable, nonvolatile optical disk 17 could be employed to store aspects of the present embodiment.

Other removable/non-removable, volatile/nonvolatile computer storage media that can be used in the exemplary operating environment include, but are not limited to, magnetic tape cassettes, flash memory cards, digital versatile disks, digital video tape, RAM 7, ROM 6, and the like. The hard disk drive 13 is typically connected to the system bus 5 through a non-removable memory interface such as interface 18. Magnetic disk drive 14 and optical disk drive 16 are typically connected to the system bus 5 by a removable memory interface, such as interface 19.

The drives and their associated computer storage media, discussed above, provide storage of computer readable instructions, data structures, program modules and other data for computing system 1. For example, hard disk drive 13 is illustrated as storing operating system 34, application programs 35, other program modules 36, and program data 37. Note that these components can either be the same as, or different from, operating system 9, application programs 10, other program modules 11, and program data 12. Operating system 34, application programs 35, other program modules 36, and program data 37 are given different numbers here to illustrate that, at a minimum, they may differ.

A user may enter commands and information into computing system 1 through input devices such as, but not limited to, a tablet, electronic digitizer, 20, microphone 21, keyboard 22, pointing device (mouse) 23, trackball, or touch pad. These and other input devices are often connected to the processing unit 3 through a user input interface 24 that is coupled to the system bus 5, or by other interfaces and bus structures, such as a parallel port, game port, or a universal serial bus (USB).

A monitor 25 or other type of display device may also be connected to the system bus 5 via an interface, such as a video interface 26. The monitor 25 may also be integrated with a touch-screen panel or the like. Note that the monitor and/or touch screen panel can be physically coupled to a housing in which computing system 1 is incorporated, such as in a tablet-type personal computer. In addition, computers such as computing system 1 may also include other peripheral output devices such as speaker(s) 27 and printer(s) 43, which may be connected through an output peripheral interface 29 or the like.

Computing system 1 may operate in a networked environment using logical connections to one or more remote computers, such as remote computing system 30. Remote computing system 30 may be a personal computing device (including, but not limited to, mobile electronic devices), a server, a router, a network PC, a peer device or other common network node, and typically includes many or all of the elements described above relative to computing system 1 (although only a memory storage device 31 has been illustrated). The logical connections depicted include a local area network (LAN) 32 connecting through network interface 38 and a wide area network (WAN) 33 connecting via modem 39, but may also include other networks. Such networking environments are commonplace in offices, enterprise-wide computer networks, intranets, and the Internet.

For example, in the present embodiment, computer system 1 may comprise the source machine from which data is being generated/transmitted and remote computing system 30 may comprise the destination machine. Note however that source and destination machines need not be connected by a network or any other means, but instead, data may be transferred via any media capable of being written by the source platform and read by the destination platform(s).

In another example, of the present embodiment, the remote computing system 30 may comprise the source machine from which data is being generated/transmitted and computer system 1 may comprise the destination machine.

In a further embodiment, of the present disclosure, computing system 1 may comprise both a source machine from which data is being generated/transmitted and a destination machine; and the remote computing system 30 may also comprise both a source machine from which data is being generated/transmitted and a destination machine.

For the purposes of this disclosure, it is appreciated that the terms “device”, “processor based mobile device”, “personal electronic device”, “mobile device”, “electronic device”, “processor based mobile electronic device”, “mobile electronic device”, and “location-capable wireless device” may be synonymous with remote computer 30.

The central processor, operating pursuant to operating system software such as IBM OS/2®, Linux®, UNIX®, Microsoft Windows®, Apple Mac OSX® and other commercially available operating systems, provides functionality for the services provided by the present invention. The operating system(s) may reside at a central location or distributed locations (i.e., mirrored or standalone).

Software programs or modules instruct the operating systems to perform tasks such as, but not limited to, facilitating client requests, system maintenance, security, data storage, data backup, data mining, document/report generation, and execution of algorithms. The provided functionality may be embodied directly in hardware, in a software module executed by a processor, or in a combination of the two.

Furthermore, software operations may be executed, in part or wholly, by one or more server(s) or a client's system, via hardware, software module, or a combination of the two. A software module (program or executable) may reside in RAM memory, flash memory, ROM, EPROM, EEPROM, registers, hard disk, a removable disk, a CD-ROM, DVD, optical disk, or any other form of storage medium known in the art. An exemplary storage medium is coupled to the processor such that the processor can read information from, and write information to, the storage medium. In the alternative, the storage medium may be integral to the processor. The processor and the storage medium may also reside in an application specific integrated circuit (ASIC). The bus may be an optical or conventional bus operating pursuant to various protocols known in the art.

A processor based mobile device, may integrate several functionalities for providing a user interface by which a user may interact with the present disclosure. The various functions provided by an electronic device in accordance with embodiments of the present disclosure, as will be described in further detail below, may generally provide users a convenient to view and interact with commercial messages.

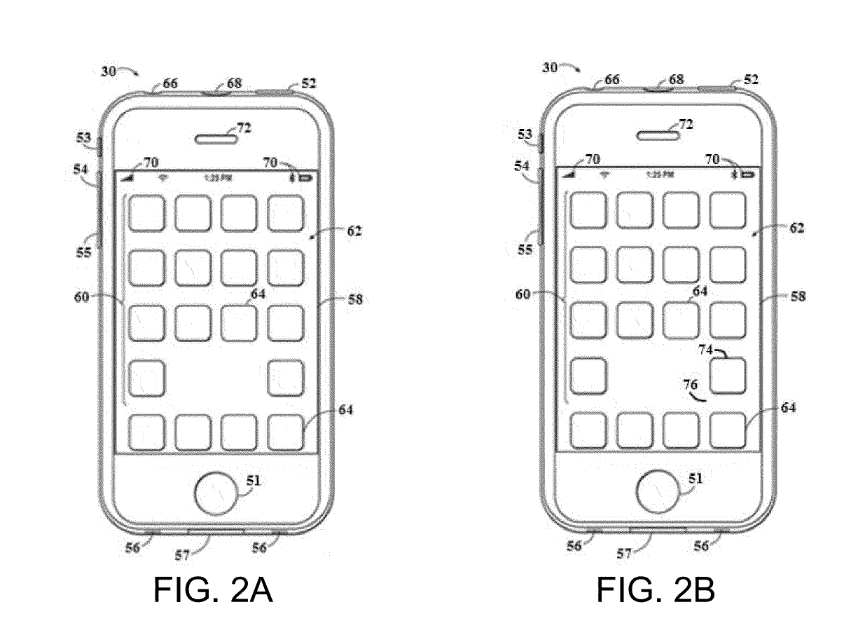

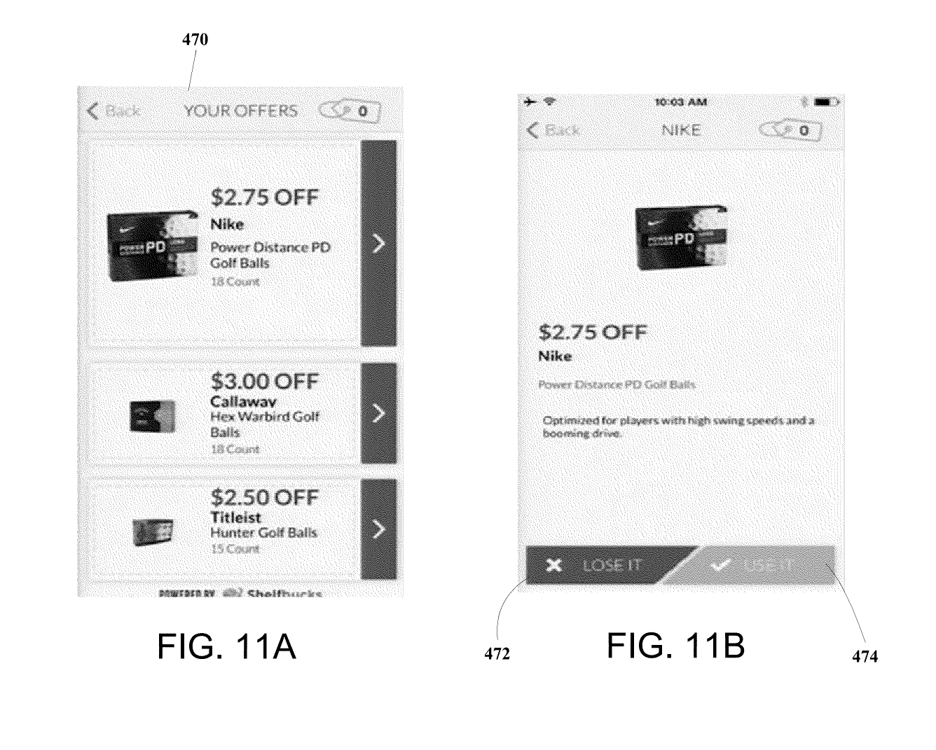

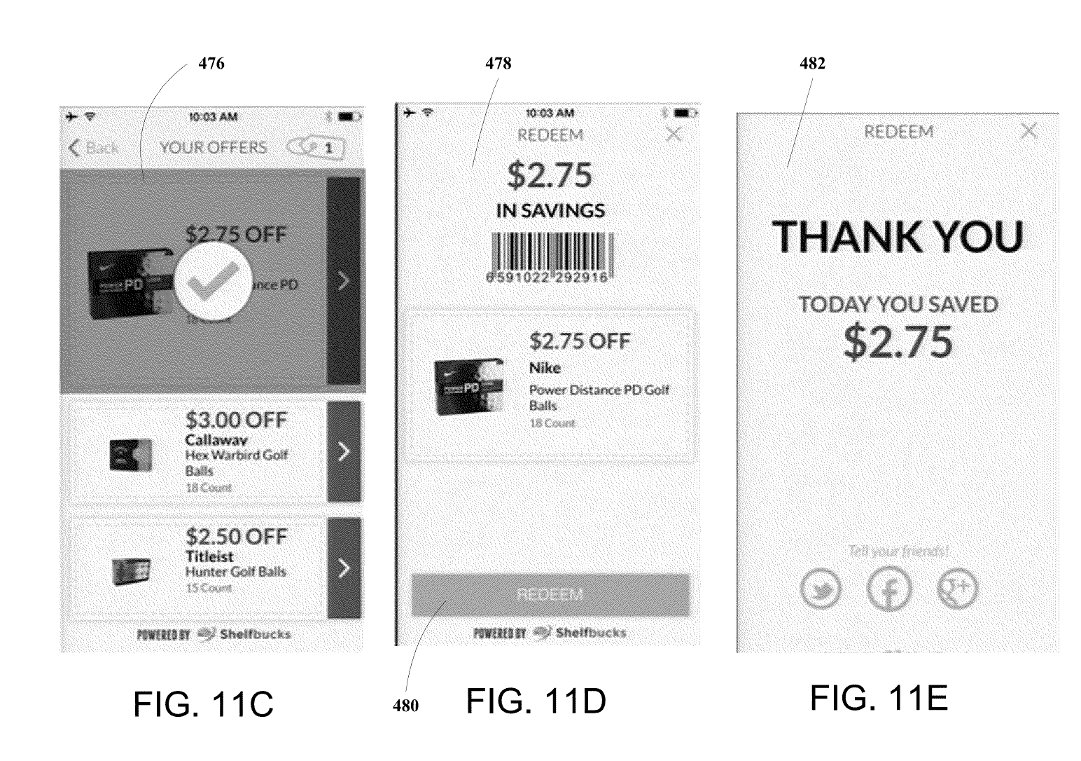

A handheld processor-based electronic device as in FIG. 2A, may include a graphical user interface, hereafter GUI, that may display the embodiments of displays described in FIGS. 11-15. While certain techniques and embodiments described reference a handheld electronic device 30 (a cellular telephone, a personal data organizer, etc.), it is appreciated that the techniques and embodiments described may be implemented and/or displayed using any suitable type of electronic device capable of carrying out the stated task, including, but not limited to desktop computers, TVs, etc.

The electronic device 30 in FIG. 2A and FIG. 2B may be handheld such as, but not limited to a cellular phone, a personal data organizer, etc. While using the electronic device 30, a user may perform one or more tasks (listen to music, talk on the phone, etc.) at one time or at different times. The electronic device 30 may also allow a user to utilize the Internet. Further, the electronic device 30 may allow for wireless communication between a user and another entity using text messaging, email, etc.

Electronic device 30 includes various input structures 51, 52, 53, 54, and 55. Using these input structures, a user may alter an electronic device function located within the electronic device 30 when the input structures 51, 52, 53, 54, and 55 are activated. For example, the input structure 51 may light up the display 58 of the electronic device 30. Another example may include an input structure 53 that may switch a call alert tone in a cell phone application between vibrate mode and ring mode. The input structures 54 and 55 may alter the volume for an application that uses sounds generated by electronic device 30. For the purposes of this disclosure, it is appreciated that the input structures 51, 52, 53, 54, and 55 are examples and do not limit the disclosure in any way. The input structures 51, 52, 53, 54, and 55 may also take the form of other structures not mentioned above.

A display 58 may be included in the electronic device 30 that may display images from the electronic device 30. Images that may be displayed include text messages, photos, and e-mails. The display 58 may also display one or more icons 70 that show the statuses of aspects of electronic device 30. An example of being an icon 70 for the strength of a cellular network (if the electronic device includes a cellular phone application). In certain embodiments, the display 58 may be any type of display, which includes, but is not limited to a liquid crystal display (LCD), a light emitting diode (LED) display, an organic light emitting diode (OLED) display, etc. The display 58 may further include a touch sensitive device associated with the display 58 that may be interacted with by the touch of a user (and would be considered another input complex in addition to input structures 51, 52, 53, 54, and 55).

A graphical user interface (GUI) 60 may be programmed into the display 58 and be shown by the display 58. The GUI 60 may include various graphical layers, windows, screens, templates, elements, or other components that may be displayed on all or a portion of the display 58. For example, the GUI 60 may display more than one icon 64. These icons 64 may be viewed on the device's home screen 62.

In another embodiment, one or more of the user input structures 51, 52, 53, 54, and 55 may be used to peruse the GUI and steer away from the home screen 62. In a further embodiment, the touch screen interface may also be used to select the icons 64.

A user may engage an icon 64, an icon 64 may cover some or all of the display 58 and be representative of various layers, windows, screens, templates, elements, or other graphical components. In addition, a hierarchical screen navigation process may exist once an icon 64 is chosen.

In one embodiment, an icon 64 that is chosen may cause the display 58 to display a screen having one or more other icons 64 or GUI elements. Furthermore, in the embodiment shown in FIG. 2B, vocabulary 76 representative of an icon 64 or another element may exist in the general area surrounding an icon 64 or other elements. For example, the icon 74 for an in-store application may further be represented by the vocabulary 76 representing the store. For the purposes of this disclosure, it is appreciated that the GUI 60 may include various elements arranged in hierarchical and/or non-hierarchical structures.

An application may be selected, opened, initiated, or run (by electronic device 30) when a user chooses an icon 64 associated with the aforementioned application.

In one embodiment, device 30 may open an application, which may provide for the management of commercial messaging by the user of the electronic device 30 when the icon 74 is chosen. When an application is chosen by a user, the display 58 may display one or more screens that may include various elements related specifically to the selected application.

Input/output (I/O) ports, for example I/O ports 57, 66, and 68, may exist in electronic device 30. Using the I/O ports, electronic device 30 may interact with one or more external devices. For example, the I/O port 66 may be an audio jack that could connect electronic device 30 to speaker (s), headphones, etc.

In an embodiment, the I/O port 68 may be configured to receive a subscriber identity module (SIM) card. Another embodiment may include an I/O port as a connection port used to send and receive data.

For the purposes of this disclosure, it is appreciated that there is no set number of I/O ports that are to be included on an electronic device 30 that may connect to any number of other devices including, but not limited to printers, power sources, computers, usb drives etc. The I/O ports may further take a shape suitable for being used in conjunction with any type of wired connection.

In a further embodiment, more than one function may be performed by an I/O port. For example, I/O port 57 may have the capability to send and receive data, as well as receive power from a power source, depending what is connected electronic device 30.

In another embodiment, electronic device 30 may include one or more audio I/O elements 56, 72, which may function as one or more input receivers and/or output transmitters. When used as an output transmitter, the one or more audio I/O elements 56, 72 may transmit sound to the user of the device. When used as an input receiver, the one or more audio I/O elements 56, 72 may receive sound. The one or more audio I/O elements 56, 72 may further be used at the same time.

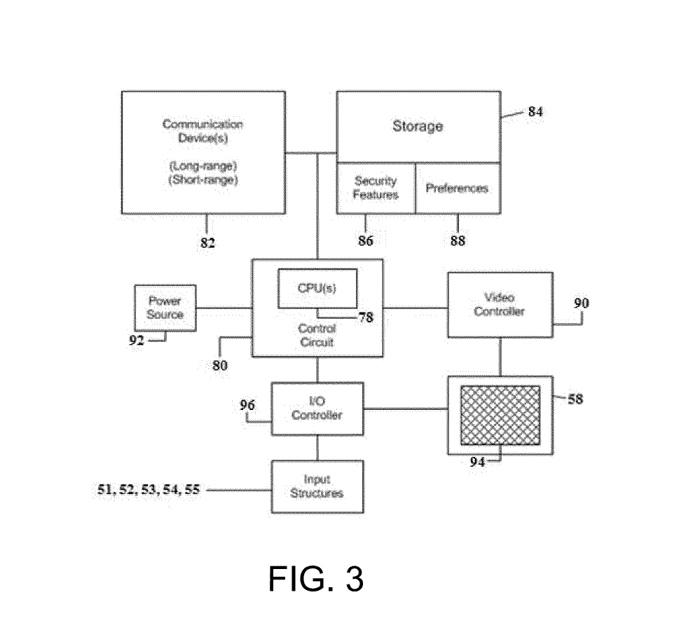

FIG. 3 depicts a basic layout of elements of electronic device 30 in accordance with one embodiment of the present disclosure. Device 30 may include a display 58, as well as a CPU 78, a touch screen interface 94, an I/O controller 96, storage device 84, one or more communication interfaces 82, a video controller 90, circuitry 80, and a power source 92.

The central processing unit (CPU) 78 and the control circuit 80 may control the operation of electronic device 30. In conjunction, these elements may provide the processing capability required to execute an operating system(s), application programs (“apps”), the GUI 60, and any other functions provided on the device 30. The control circuit 80 may include one or more data buses for transferring data and instructions between components of the device 30. The control circuit 80 may further include on board memory for caching purposes.

The CPU 78 may include one or more processors. For example, the CPU 78 may include, but are not limited to “genera purpose” microprocessors, a combination of general and application-specific microprocessors, instruction set processors, graphics processors, video processors, as well as related chips sets, and/or special purpose microprocessors. The device 30 may also include standalone RAM in communication with the CPU 78 by way of one or more memory controllers, which may be integrated within the control circuit 80.

The CPU 78 may use information that may be stored within a long-term storage device 84. The storage device 84 of the electronic device 30 may be utilized for storing data required for the operation of the CPU 78, data to be processed or executed by the CPU 78, as well as other data required by the electronic device 30. For, example, the storage device 84 may be configured to store the firmware for the electronic device 30 that is used by the CPU 78. The firmware may include, but are not limited to an operating system(s), GUI functions, and/or processor functions, as well as other programs or drivers that enable various functions of the electronic device 30. The storage device 84 may also store components for the GUI 60, such as graphical elements, screens, and templates. The storage device 84 may also store data files such as media (e.g., music and video files), image data, application software, user preference information, network connection information (e.g., information that may enable the electronic device 30 to establish a wireless connection), subscription information, telephone information, and any other suitable data required by the electronic device 30. The long term storage 84 may comprise non-volatile memory, solid state memory, a hard disk drive, or any other suitable computer readable media, or any combination thereof.

Included in electronic device 30 may be one or more network communication devices 82 for providing additional channels for receiving and transmitting information. For example, the communication device 82 may represent a network controller as well as various associated communication protocols. The communication device 82 may provide for various long-range communication interfaces, including, but not limited to, a wireless local area network (WLAN) interface, a local area network (LAN) interface 32, or a wide area network (WAN) interface 33. For example, a WAN interface 33 may permit a private and/or secure connection to a cellular data network. The network communication device 82 may further provide a short message service (SMS) interface.

The communication device 82 may further provide for short-range communication interfaces, such as a personal area network (PAN) interface. The PAN interface may provide capabilities to network with, for example, a Bluetooth® network, Bluetooth low energy, hereafter BLE, near field communication, hereafter NFC, or an ultra-wideband network (UWB). The communication device 82 may include any number and combination of network interfaces. The network device may employ one or more protocols, such as a High-Speed Downlink Packet Access (HSDPA) protocol, for rapidly downloading data over a network. The network communication device 82 may additionally allow the electronic device 30 to receive software upgrades.

Electronic device 30 may further include a service discovery networking protocol to establish a connection with an external, device through a network interface. For example, both the electronic device 30 and the external device may broadcast identification information using Internet protocol (IP) standards. The external device may additionally broadcast information relating to services the external, device is capable of providing (e.g., printing services for a networked printer). The devices may then establish a network connection using said identification information.

Properties of the above-mentioned communication interfaces provided by the network communication device 82 may further be determined by user preference settings 88. The user preference settings 88 may be stored in the storage device 84. For instance, the preferences 88 may include a list of networks that electronic device 30 may connect to and may further govern the order or priority between the communication interfaces.

Further, the communication preferences associated with the preferences 88 may be further dependent upon security features 86 available for each respective communication interface. The security features 86 may be stored in the storage device 84 and may include one or more cryptographic protocols, such as a secure sockets layer (SSL) protocol or a transport layer security (TLS) protocol, for establishing secure communications between the electron device 30 and an external device. The security features 86 may also include one or more encryption applications for encrypting information sent from electronic device 30. These features may be particular useful when transmitting information of a sensitive nature, which may include credit card and bank account information.

To limit access to the sensitive data, such as encryption keys, passcodes and passwords, digital certificates, etc. The security features 86 may also include a secure access-restricted storage area (e.g., within the storage device 84).

In some embodiments, the secure storage area 84, in addition to storing the above-mentioned sensitive data, may be further protected by its own respective password, authorization, or “personal identification number” (PIN) in order to prevent unauthorized access to information stored therein.

The video controller 90 may be operably coupled to the display 58 and configured to receive image data and to send voltage signals corresponding to the pixel values of the image data to the display 58. The displayed image data may represent information received through the communication interface 82, as well as information contained in the storage device 84. Pixel values may be numerical assignments corresponding to respective pixel intensities. Therefore, the display 58 may receive the voltage signals from the video controller 90 as an input and produce an image corresponding to the voltage signals. With reference to FIG. 11, an image produced by the signals provided by the video controller 90 may represent a screen of the GUI 60 described above.

A user may select various graphical elements which may represent applications or information that may be displayed through the GUI 60. A touch screen interface 94 may be positioned in front of or behind the display 58 and may provide a user the ability to select graphical elements, such as the icons 64 displayed by the GUI 60 as in FIG. 2A and FIG. 2B. The touch screen interface 94 may be configured to receive inputs based on a physical contact either by the user or an object being controlled or manipulated by the user, and to send “touch event” information to the CPU 78. The CPU 78 may then process the detected touch event information and perform a corresponding action. For example, referring briefly back to FIG. 2A and FIG. 2B, the “touching” of the icon 64 may be processed by the CPU 78 as an instruction to execute or initiate the corresponding application. The touch screen interface 94 may employ any suitable type of touch screen technology such as resistive, capacitive, infrared, surface acoustic wave, electromagnetic, or near field imaging. The touch screen interface 94 may further include single point or multipoint sensing.

A user may communicate with the CPU 78 through various input structures utilizing the infrastructure provided by the I/O controller 96. The input structures provided on electronic device 30 include input structures 51, 52, 53, 54, and 55 as shown in FIG. 2A and FIG. 2B. The user input structures 51, 52, 53, 54, and 55 may be used in conjunction with, or independently of, the touch screen interface 94 to provide input information to electronic device 30.

Electronic device 30 may be powered by the power source 92 in both non-portable and portable settings. In a portable setting, for instance, in order to facilitate transport and ease of motion, electronic device 30 may include an integrated power source 92 for powering the electronic device 30. The power source 92 may include one or more batteries, such as a Li-Ion battery, which may be user-removable or secured to the electronic device 30.

In specific embodiments, the proprietary connection I/O port 57 may be used to connect the electronic device 30 to a power source in order to recharge the battery. In other embodiments, the one or more batteries may be non-integrated and may include one or more rechargeable or replaceable batteries. Further, in a non-portable setting, the power source 92 may include AC power, such as provided by an electrical outlet.

Generally, depicted screen images may be generated by the GUI 60 and displayed on the display 58. For instance, these screen images may be generated as the user interacts with the electronic device 30, such as via the input structures 51, 52, 53, 54, and 55, and/or the touch screen interface 94. As discussed above, the GUI 60, depending on the inputs and selections made by a user, may display various screens including icons (e.g., 64) and graphical elements. These elements may represent graphical and virtual elements or “buttons” which may be selected by the user by physically touching their respective location on the display 58 using the touch screen interface 94. Further, the functionalities set forth and described in the figures may be achieved using a wide variety of graphical elements and visual schemes. It should also be understood that the present disclosure is not intended to be limited to the precise user interface conventions depicted herein. Embodiments of the present invention may include a wide variety of GUI 60 styles.

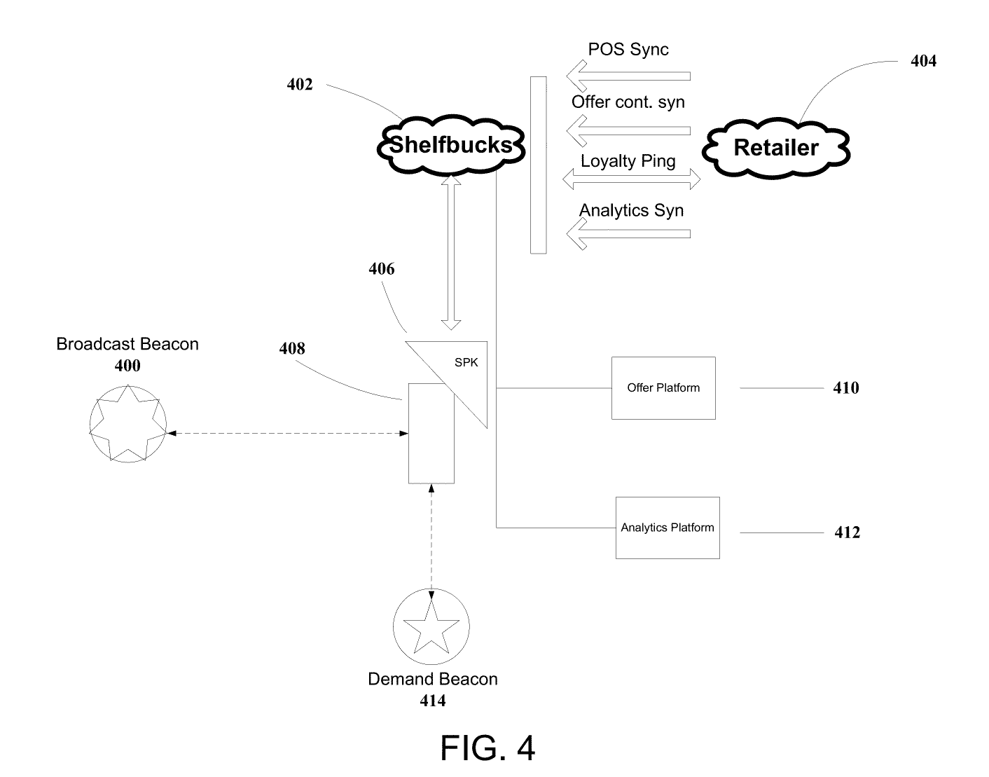

FIG. 4 illustrates an exemplary system of the present disclosure comprising: a commercial message sub-system 402; a retailer subsystem 404; a PED, 408 which is capable of running applications; and a beacon for the broadcast of commercial messages to the consumer's PED 404.

In one embodiment the beacon is a demand beacon 414.

In another embodiment the beacon is a broadcast beacon 400. In the example presented, the commercial messages sub-system 402 has a list of possible commercial messages, which are provided by one or more retailers and/or brands 404. The commercial messages sub-system is capable of interacting with a plurality of platform specific programs operable on PEDs and/or directly with the beacons.

One embodiment of the present disclosure additional comprises a software packaging kit, hereafter SPK, which can facilitate the integration of existing platforms or applications with the commercial messages sub-system 402. In another embodiment, the SPK can facilitate the design of application.

Each beacon contains a sub-set of commercial messages that are sourced from the commercial messages sub-system 402. In some embodiments, the beacon(s) are provided with a direct connection to the commercial messages sub-system, via Ethernet, wireless connections, or other known connections. In other embodiments, the beacon is not directly connected to the commercial messages sub-system 402 and instead receives data packets via one or more consumer associated PEDs 408. Embodiment of this arrangement can receive updated advertisement information by establishing a network connection to the messages sub-system 402 via a PED 408.

The commercial messages can be provided to the commercial messages sub-system 402 by retail and brand marketers. In some embodiments these commercial messages are provided by marketers utilizing an offer platform 410, which provides a mechanism for designing and introducing new commercial messages.

For the purposes of the present disclosure, the term “marketer” is intended to represent any individual, company or organization that prepares, transmits, or analyzes commercial messages. Examples of these commercial messages can include, but not limited to, to coupons, pricing, pricing specials, product details, advertisements, etc.

In another embodiment, the advertiser sub-system can interact with a marketers existing legacy system 404, and utilize these advertisements as part of the database 402. Some embodiments, enable the transfer of traditional-printed coupons into an electronic format for viewing by consumers using PEDs.

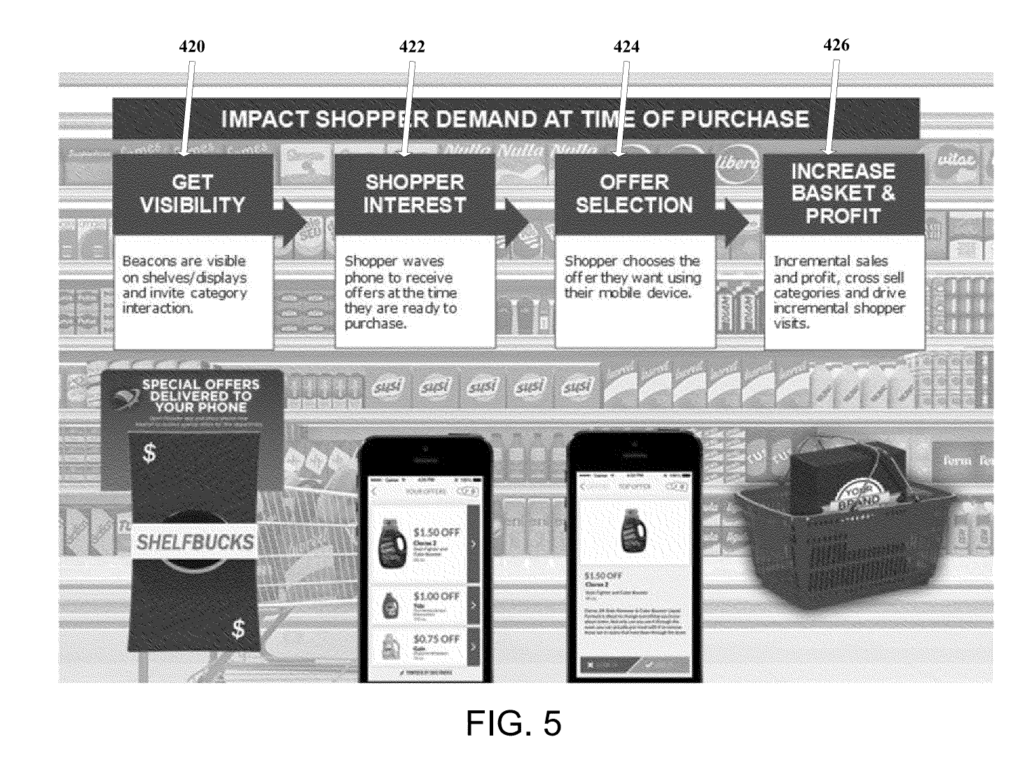

FIG. 5 illustrates a flow chart diagram of an exemplary system of the present disclosure. In step 1 420, a shelf of a typical store displays products for sale and displays a demand beacon. In step 2 422, a consumer that is interested in obtaining further information about a product for sale interacts with the beacon. In the embodiment presented, a consumer places a PED into proximity with the beacon. In step 3 424, the beacon broadcasts a commercial messages to the PED. Said commercial message being sourced from the commercial messages database, and related to that particular product, product line, shelf, or location within the store, etc. The consumer chooses the desired offer from a list of potential offers using a PED.

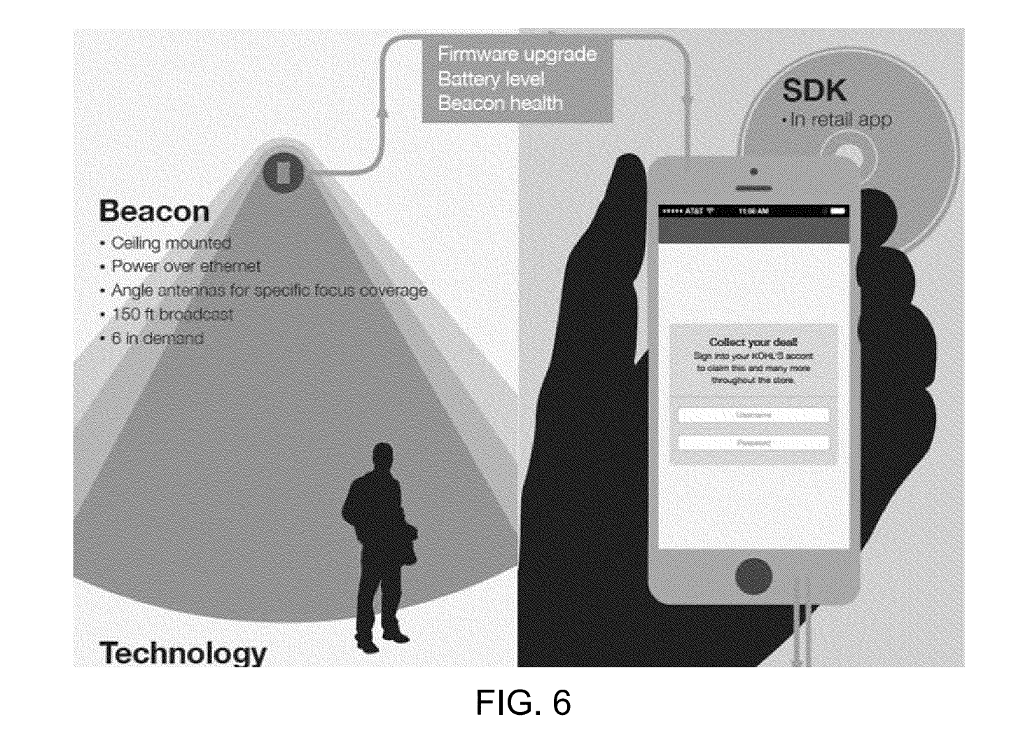

FIG. 6 presents a further embodiment of the present disclosure where in contrast to the embodiment presented in FIG. 5, the commercial messages system utilized a broadcast beacon for interaction with consumers. In this embodiment, the positioning of the broadcast beacon facilities a broad based communication to all PEDs within the defined zone. In some embodiments, a broadcast beacon may be located in a ceiling to facilitate a broad zone.

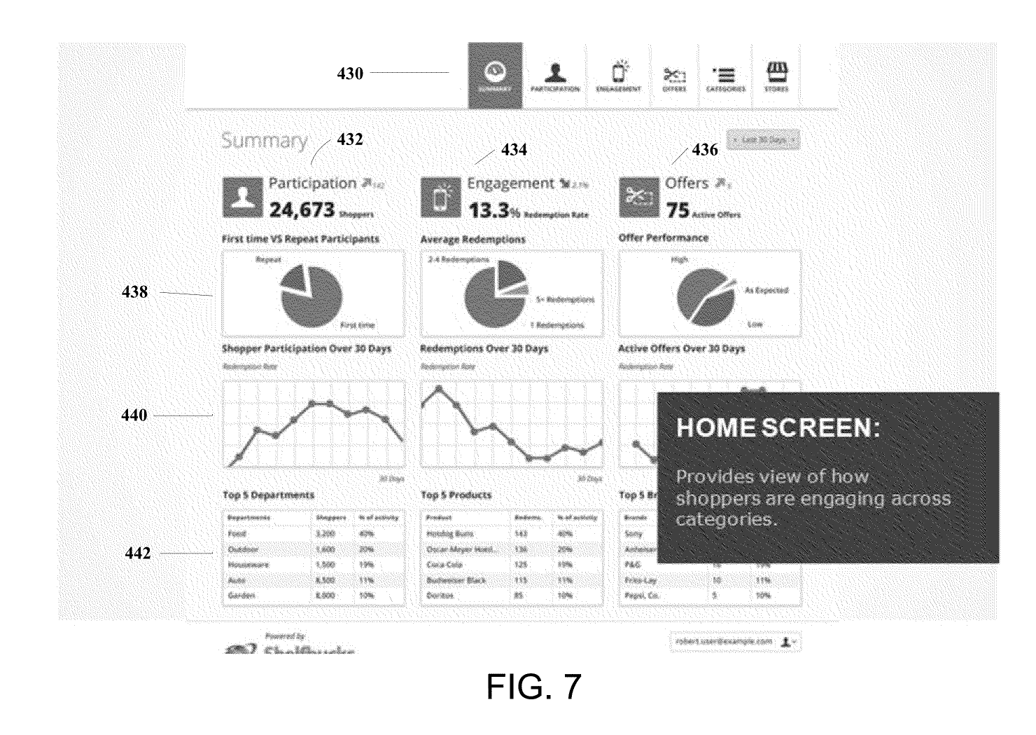

FIG. 7 presents an exemplary analytics platform 430 of the present disclosure. Embodiments of the analytics platform can enable marketers to track and analyze the effectiveness of an advertising program. Exemplary features can include a participation 432 report, an engagement report 434, and an offers report 436. Exemplary methods of presenting reports can include charts, graphs, (i.e. bar 438 and pie charts 440), and statistics 442.

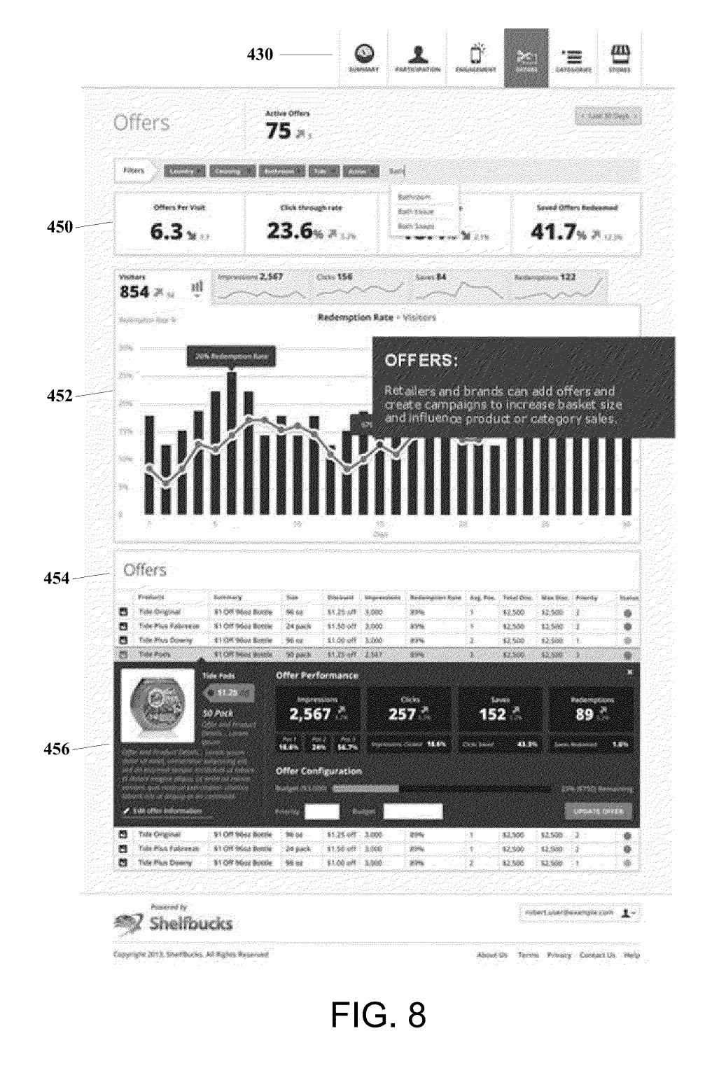

FIG. 8 presents a further embodiment of the analytics platform wherein marketers are able to track, observe, and analyze the effectiveness of a specific commercial message or offer that is being marketed.

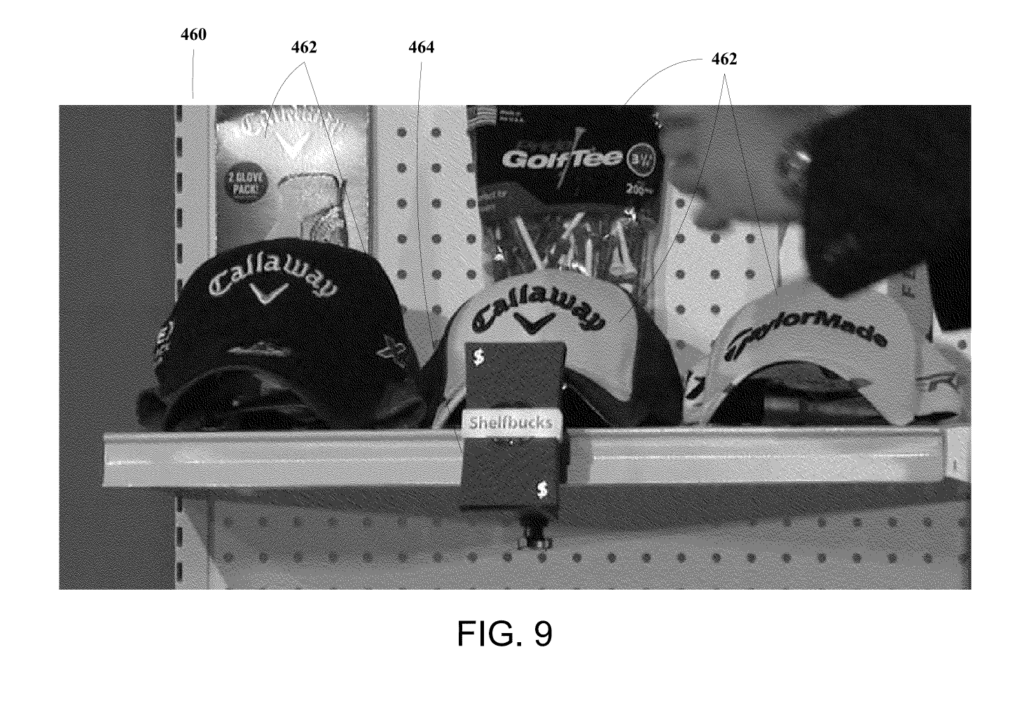

FIG. 9 presents a further embodiment of the analytics platform wherein marketers are able to track, observe, and analyze the engagement with regards to a product or offer.

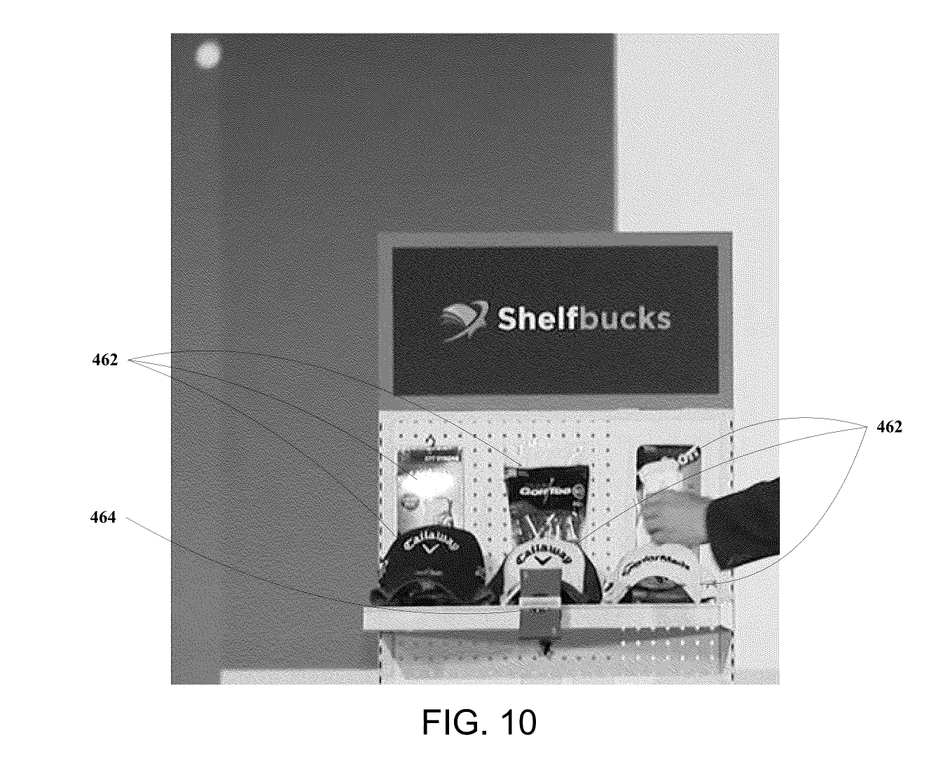

FIG. 10 presents a shelf 460 supporting an exemplary demand beacon 464 and displaying a product 462 for sale.

FIG. 11 presents the exemplary demand beacon 464 of FIG. 9 being interacted with by a consumer. In this embodiment, the consumer places their PED adjacent to the demand beacon. The beacon, upon confirming an active connection to the device, then broadcasts a commercial message.

In some embodiments, the beacon broadcasts a first transmission for establishing a connection to the PED. Exemplary methodologies of this step include the beacon broadcasting a short-range transmission, which can establish a connection with a PED, and wake a non-active associated application started thereon. In some embodiments, this short-range transmission for establishing a connection utilizes iBeacon protocols or other protocols which can transmit a unique identifier able to be received by a compatible application or operating system, which then identifies a physical location or triggers an action on the device. In a further embodiment, the beacon broadcasts a second secured transmission, which comprises the commercial messages. In some embodiments, the second secured transmission utilizes Bluetooth Low Energy, hereafter BLE, or Near Field Connections, hereafter NFC.

In one embodiment, the short-range iBeacon transmission may be limited to a distance of 6 inches.

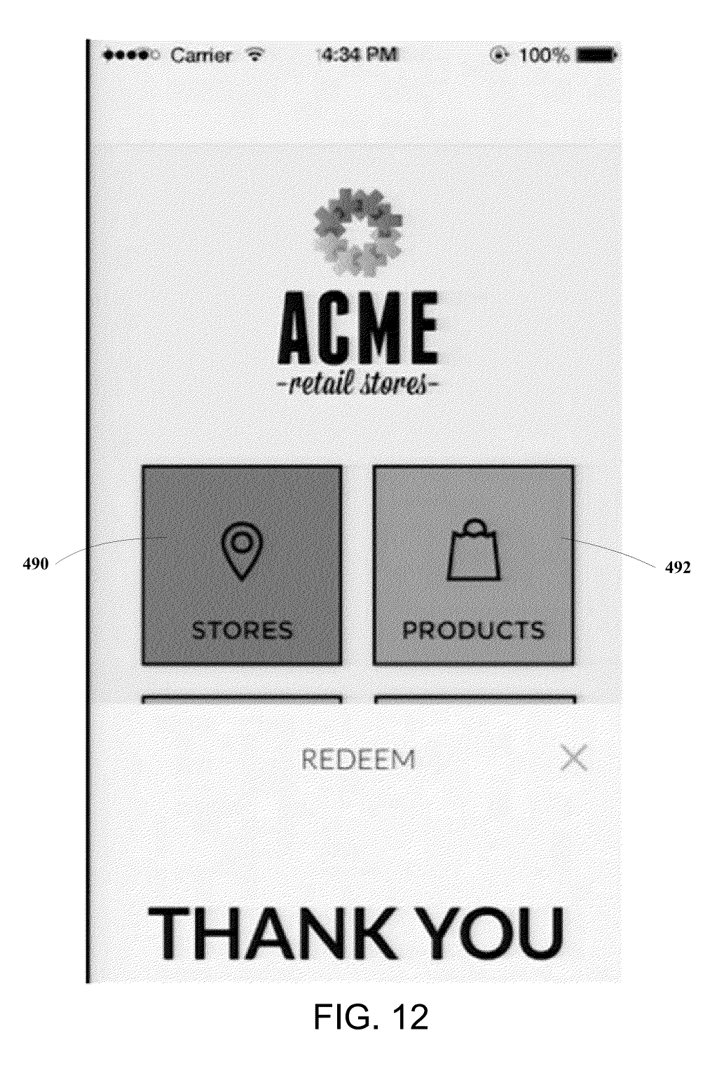

FIGS. 12A and 12B present exemplary screenshots from a PED utilizing an application 470 of the present disclosure. FIG. 11A presents a screenshot output from a consumer's device after the device has received a commercial message from a beacon (either demand or broadcast).

In the example presented, the consumer has expressed an interest in purchasing golf related items, and the consumer has therefore interacted with a beacon with the intention of receiving additional information about the product. The consumer PED will then receive and present the available commercial message, which in this case is three potential coupons each with a corresponding discount. This embodiment enables the consumer to peruse each of the available discounts (as presented in FIG. 11B), and subject to an available offer meeting the consumers requirements, make a selection (as presented in FIG. 11C).

Embodiments of the present disclosure can also enable a consumer to interact with the point of sale. FIG. 11D illustrates an example of a PED presenting one or more barcodes selected by the consumer to a casher. In an alternative embodiment, the application on the PED may interact with a device associated with the casher or point of sale, i.e. the selected coupons may be transmitted wirelessly.

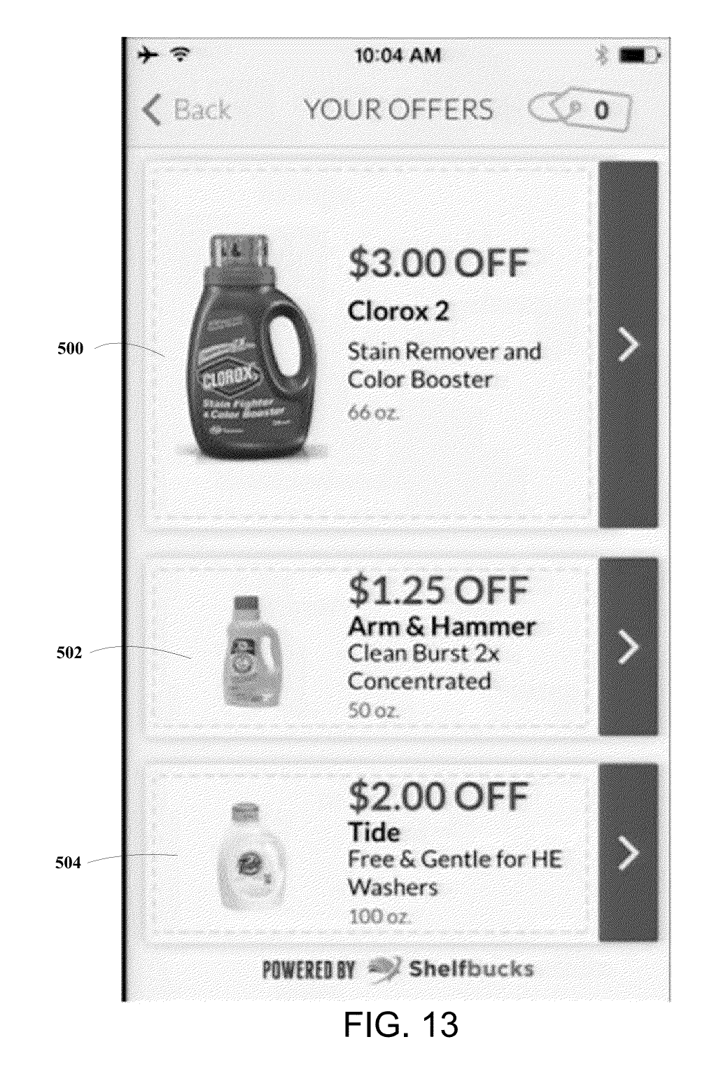

FIGS. 13-15 present various screenshots of a marketer's potential interactions with the system. In FIG. 13, an embodiment of the present disclosure presents three product choices and the accompanying discounts or coupons to a consumer.

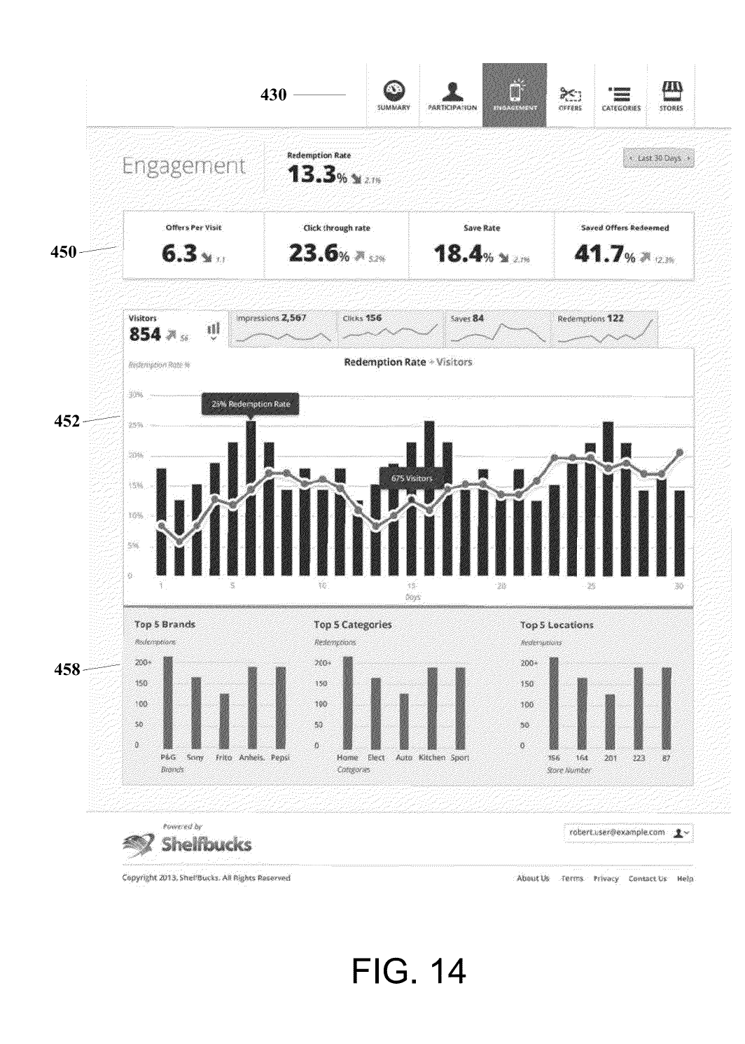

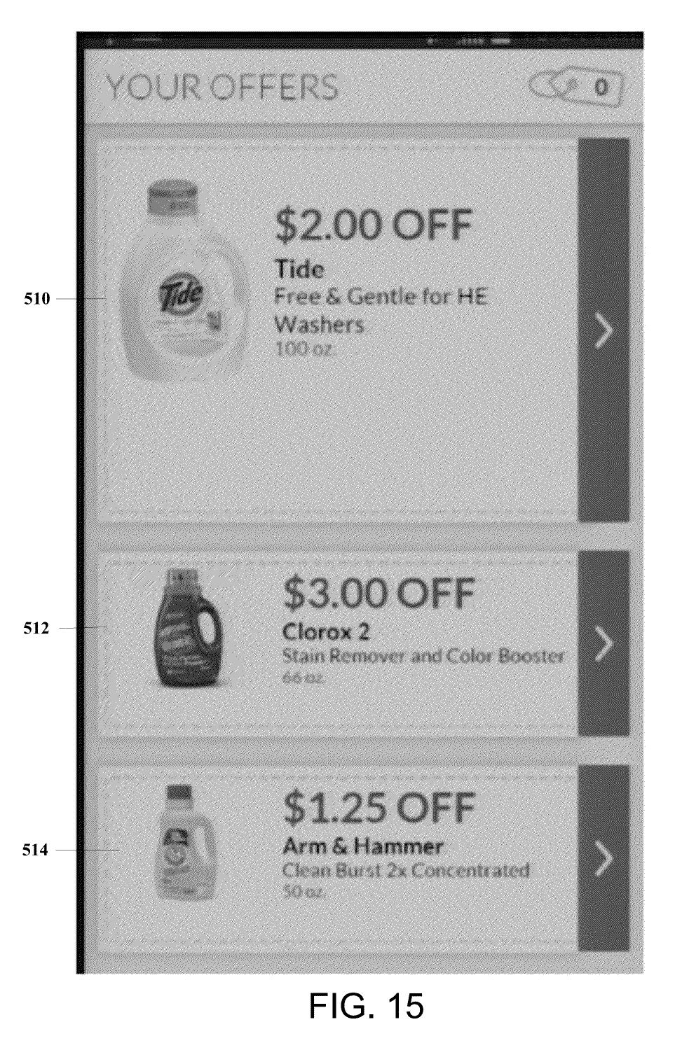

FIGS. 14 and 15 presents a scenario wherein a marketer of “tide” has determined that the sale of the product is less than that desired. In FIG. 14 three products are presented to a potential consumer from top to bottom in the order of 500, 502, and 504.

In contrast FIG. 15 presents the same three products, 510, 512 and 514, in a differing order after the marketer has interacted with the system. In one embodiment, a marketer may achieve this reordering of products by reducing the price of the product and the system being configured to order the products on the basis of best value product. In another embodiment, the system may be configured to prioritize products based on a number of differing configurations. Examples of these configurations can include, but not limited to, a priority system wherein a marketer purchases a specific presentation position or location within the application. Further embodiments include options for presenting commercial messages on an analysis of the frequency of presentation and the likelihood of presentation, etc.

In a further embodiment, the system can be configured to alter the presentation of material on a global basis. In yet a further embodiment, the system can be configured to alter the presentation of material on a store-by-store or regional basis. In further embodiments, the system could utilize other analytical, demographic, regional or other known categorical method known in the art.

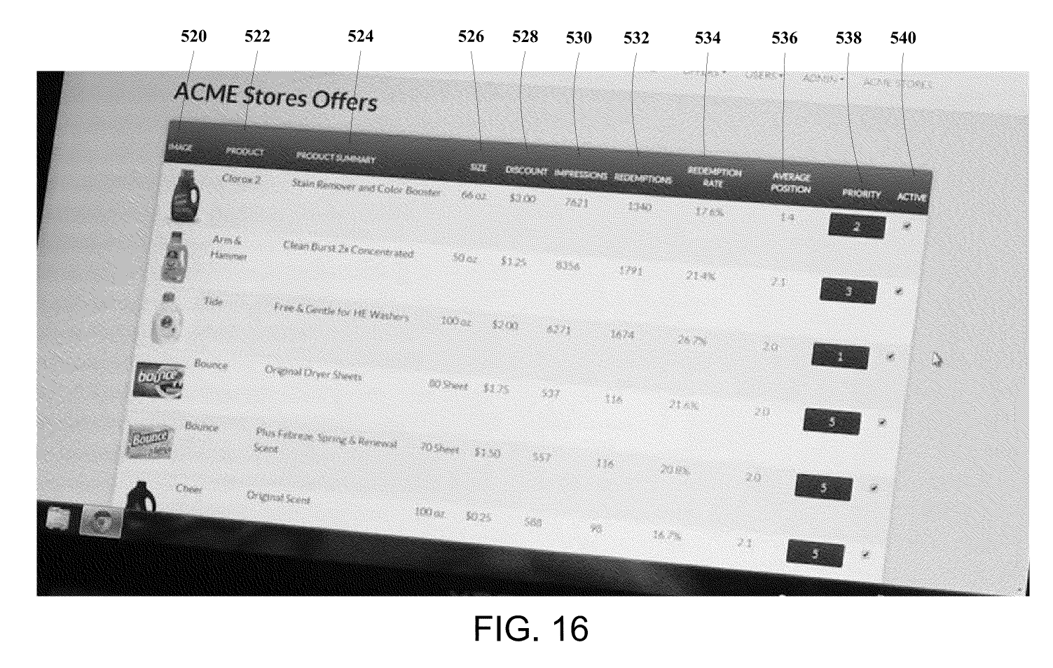

FIG. 16 presents a screenshot of an exemplary analytics platform for marketers. This screenshot displays a category for image 520, product 522, product summary 524, size 526, discount 528, impressions 530, redemptions 532, redemption rate 534, average position 536, priority 538 and active 540. The embodiment presented in FIG. 14 enables a marketer to influence the relative effectives of a marketing campaign by influencing the coupon directly (i.e. reducing the price) or indirectly (i.e. influencing the likelihood of presenting the coupon or the position of presentation).

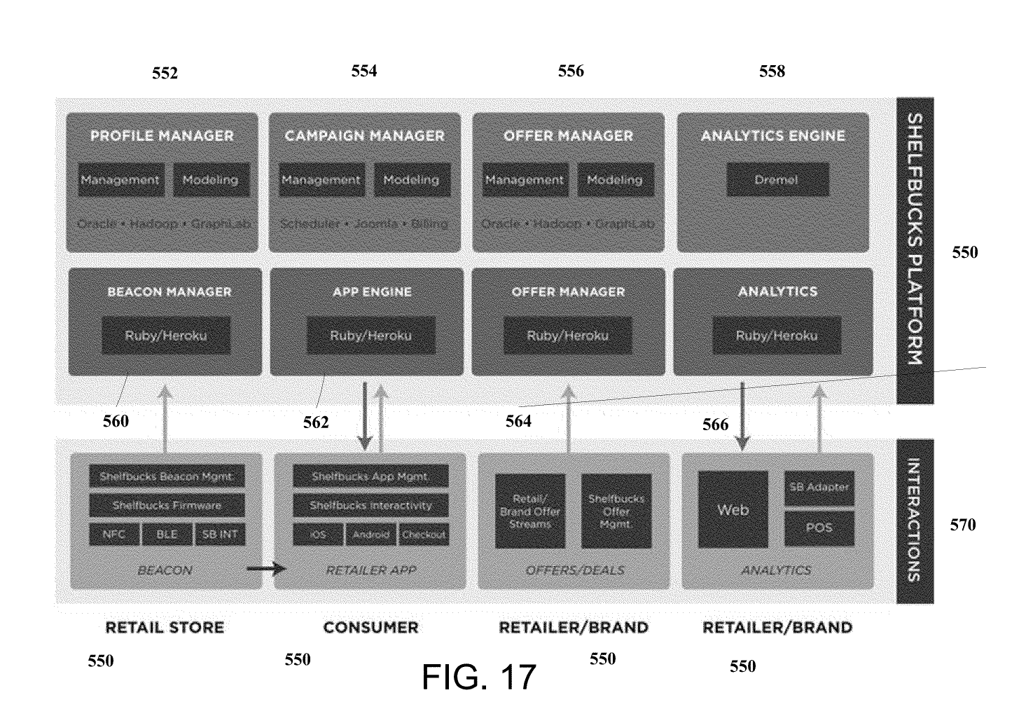

FIG. 17 presents further details of an exemplary system and the potential interactions of the various aspects. This includes potential interactions between the exemplary users and marketers and administrators, including retail stores, consumers, and the retail/brands.

What is claimed is:

1. A system for transmitting in-store advertisement comprising:
a consumer associated personal electronic device (PED), said PED running an application associated with a store;
a database located on a computer system, comprising a number of commercial messages;
a beacon for connecting to said database and transmitting a portion of said number of commercial messages to said application located on said PED;
wherein said beacon is selected from the group comprising:
a broadcast beacon, wherein said beacon transmits to all associated applications located within a broadcast zone; and
a demand bacon, wherein said beacon's transmission range is not greater than 6 inches;
wherein said beacon's broadcast comprises a first protocol transmission for establishing a connection to said PED, and a second transmission for communicating said commercial messages;
a protocol for connecting said database to a second database, enabling a:
outputting a tracked result of said commercial message; and
obtaining information from said second database information related to a consumer.

2. A system for broadcasting in-store advertisement comprising:
a consumer associated personal electronic device (PED), said PED running an application associated with a store;
a database located on a computer system, comprising a number of commercial message;
a beacon for connecting to said database and transmitting a portion of said number of commercial messages to said application located on said PED;
wherein said beacon is selected from the group comprising:
a broadcast beacon, wherein said broadcast beacon transmits to all located within a broadcast zone; and
a demand bacon, wherein said demand beacon's transmission range is not greater than 6 inches.

3. The system of claim 2, wherein said beacon transmission comprises a first protocol transmission for establishing a connection to said PED, and a second transmission for communicating said commercial message.

4. The system of claim 3, wherein said second transmission is selected from the group consisting of:
BLE; and
NFC.

5. The system of claim 2, wherein said commercial messages transmitted by said beacon are updated by establishing a link between said beacon and said database via said PED.

6. The system of claim 2, wherein said beacon has an Ethernet connection for connecting to said database, and powering said beacon.

7. The system of claim 2, wherein said database additionally comprises information pertaining to said consumer, said information comprising:
a unique identification number, said unique identification number selected from the group consisting of:
an identification number associated with said PED;
a store associated identification selected from the group consisting of:
a consumer loyalty card number.

8. The system of claim 2, wherein said computer system additionally comprises an offer platform.

9. The system of claim 8, wherein said offer platform is capable of fulfilling a store associated legacy marketing system's output.

10. The system of claim 2, wherein said computer system additionally comprises an analytics platform for tracking a result of said advertisement.

11. The system of claim 2, wherein the methodology of said broadcast of said advertisement to said PED is selected from the group consisting of:
a priority; and
slotting.

12. The system of claim 2, additionally comprising a second database, wherein said database connects to said second database, and said connection provides a means for:
outputting the tracked results of said advertisement;
obtaining information from said second database.

13. A method for establishing a secure connection between an in-store beacon and an associated application located on a consumer associated personal electronic device, said method comprising the steps of:
transmitting a first transmission for activating said application;
transmitting a second transmission comprising an commercial message to said application.

14. The method of claim 13, wherein said first transmission and said second transmission is over a distance not greater than 6 inches.

15. The method of claim 13, wherein said beacon transmits to all associated applications located within a broadcast zone.

16. The method of claim 13, wherein said second transmission is selected from the group consisting of:
BLE;
(any other options?); and
NFC.

17. The method of claim 13, additionally comprising providing an offer platform.

18. The method of claim 17, wherein said offer platform integrates with a store associated legacy marketing system.

19. The method of claim 13, additionally comprising providing an analytics platform for tracking a result of an advertisement.
